(19) United States
(12) Patent Application Publication
(10) Pub. No.: US 2004/0193920 A1
(43) Pub. Date: Sep. 30, 2004

(54) Service provisioning in a communication system

(76) Inventors: Krisztian Kiss, San Diego, CA (US); Gabor Bajko, Budapest (HU)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/462,825

(22) Filed: Jun. 17, 2003

(30) Foreign Application Priority Data
Mar. 25, 2003 (GB) 0306864.0

(51) Int. Cl. G06F 15/173

(52) U.S. Cl. 713/201; 709/223

(57) ABSTRACT

An apparatus and method requests a service by one party on behalf of another party. The method comprises the steps of requesting by the one party a service on behalf of the another party, the request including identity information of the another party, authenticating the one party and modifying the request to include identity information of the one party and permitting the one party to receive the service on behalf of another party, depending on the identity information of at least the another party.

### BACKGROUND OF THE INVENTION

1. Field of the Invention

The invention relates to a method of providing a service in a communications network.

2. Description of the Related Art

A communication system is a facility that enables communication between two or more entities such as user terminal equipment and/or networks entities and other nodes associated with the communication system. The communication may comprise, for example, communication of voice, electronic mail (email), text messages, data, multimedia and so on.

The communication may be provided via fixed line and/or wireless communication interfaces. A feature of the wireless communication systems is that they provide mobility for the users thereof. Examples of communication systems providing wireless communication include the public land mobile network (PLMN) and wireless data networks such a Wireless Local Area Network (WLAN). Examples of the fixed line systems include the public switched telephone network (PSTN) and various fixed line data networks.

A communication system typically operates in accordance with a given standard or specification which sets out what the various elements of the system are permitted to do and how that should be achieved. For example, the standard or specification may define if the user, or more precisely, user equipment is provided with a circuit switched service or a packet switched service or both. Communication protocols and/or parameters which shall be used for the connection are also typically defined. For example, the manner how communication shall be implemented between the user equipment and the elements of the communication network is typically based on a predefined communication protocol. In other words, a specific set of “rules” on which the communication can be based on needs to be defined to enable the user equipment to communicate via the communication system.

Each communication system operates by running various different functions. For example, in communication environments such as those based on protocols such as the Internet Protocol (IP) or the Session Initiation Protocol (SIP) or the current third generation (3G) communication network architectures it is assumed that various servers are used for handling the provisioning of different communication services for users. In such communication systems the communication connections may not be based on a “circuit” between the communicating nodes, but the messages may rather be transported as packets that are provided with destination address information. Hence the name packet switched systems. The server entities and the user equipment may communicate with each other based on appropriate protocols providing such a connectionless operation.

The 3G Partnership Project (3GPP) is defining a reference architecture for the Universal Mobile Telecommunication System (UMTS) core network which will provide the users of UE (user equipment) with access to these services. This UMTS core network is divided into three principal domains. These are the Circuit Switched domain, the Packet Switched domain and the Internet Protocol Multimedia (IM) domain. The latter of these, the IM domain, makes sure that multimedia services are adequately managed. The IM domain supports the Session Initiation Protocol (SIP) as developed by the Internet Engineering Task Force (IETF).

Session Initiation Protocol (SIP) is an application-layer control protocol for creating, modifying and terminating sessions with one or more participants (endpoints). SIP was generally developed to allow for initiating a session between two or more endpoints in the Internet by making these endpoints aware of the session semantics. A user connected to a SIP based communication system may communicate with various entities of the communication system based on standardised SIP messages. User equipment or users that run certain applications on the user equipment are registered with the SIP backbone so that an invitation to a particular session can be correctly delivered to these endpoints. To achieve this, SIP provides a registration mechanism for devices and users, and it applies mechanisms such as location servers and registrars to route the session invitations appropriately. Examples of the possible sessions include Internet multimedia conferences, Internet telephone calls, and multimedia distribution. Those interested will find a more detailed description of the SIP from an Internet Engineering Task Force (IETF) specification by J. Rosenberg et al titled “SIP: Session Initiation Protocol”, RFC 3261, July 2002. This document is incorporated herein by reference.

A protocol defined in the Internet Engineering Task Force (IETF) specification “SIP: Specific Event Notification”, RFC 3265, July 2002 by A. Roach describes a SIP event framework for the provision of an IP-based event delivery mechanism. This document is also incorporated herein by reference.

The SIP event framework can be used for enabling event-based information provisioning to any node in the Internet. Examples of information that may be provided for the users include presence information, location information, content/service availability information, information regarding any kind of access-controlled SIP events, and so on. The term event shall be understood to refer to any event that may be present in a communication system. For example, an event may comprise a dynamic or static mark up language document (e.g. a HTML (Hypertext Mark-up Language) or XML (Extensible Mark-up Language) document), or any other entity that may change its state and may associate with a user of the communication system.

Users or application servers subscribing to a presence service can determine the ability and availability of another user e.g. to accept a call (depending on the equipment and service provider) among other presence features/attributes. However, in systems supporting SIP, presence can assume a variety of indicators such as ‘in the office and available for all calls’, ‘at home and available for private calls only’, and ‘busy in call’ (or at least appear that way). Thus presence information allows a user to ascertain the availability of another user before attempting to make a call. The presence service can provide more than just information such as whether the other user is either available or unavailable. It can contain visual, animated or sound elements and can describe various issues for example related to a game session.

Reference is also made to draft-ietf-simple-presence-10 which defines the Presence Event Package for SIP, as a utilization of RFC 3265 and which is hereby incorporated by reference. The IETF standard RFC 3325 defines a Privacy Mechanism for SIP, the trust domain concept and is hereby incorporated by reference. The 3GPP IMS Presence Service is currently described in 3GPP TS 23.241 6.1.0 (Stage-2), 3GPP TR 24.841 0.5.0 (Stage-3) and these documents are hereby incorporated by reference.

3GPP IMS Release 6 introduces the Presence Service in relation to the multimedia environment. The document listing the 3GPP Presence requirements towards IETF (Requirements for Presence Service in 3GPP Wireless Systems, draft-kiss-simple-presence-wireless-reqs-02) contains two requirements related to the situation when an entity subscribes for a presentity's presence state change on behalf of another entity.

The first requirement is SUBNOT-REQ7, which enables subscriptions on behalf of another user. It is possible for a watcher to subscribe to the presentity's (the user or user equipment being watched) presence information on behalf of another user. As an example, an Application Server may act as a network-based watcher to provide presence based call control, or a Resource List Server may collect notifications from the individual resources of the presentity collection on behalf of the watcher.

The second requirement is AUTH-REQ8, which enables authorization of subscriptions generated on behalf of another user. It is possible for the Presence Server to authorize subscriptions to presentity's presence information which are generated on behalf of another user. It should be possible for the presentity to set authorization rules taking into account both the identity of the watcher and the identity of the user on whose behalf the subscription is made.

However there has been no discussion as to how this requirement can be fulfilled in practice.

### SUMMARY OF THE INVENTION

According to one embodiment of the invention, there is provided a method of requesting a service by one party on behalf of another party comprising the steps of requesting by the one party a service on behalf of the another party, the request including identity information of the another party, authenticating the one party and modifying said request to include identity information of the one party, and permitting the one party to receive the service on behalf of said another party, depending on the identity information of at least the another party.

According to a second embodiment of the invention, there is provided a method of requesting a service by one party on behalf of another party. The method includes the steps of requesting by the one party a service on behalf of the another party, the request including identity information of the another party, permitting the one party to receive the service on behalf of the another party in dependence on the identity information.

According to a third embodiment of the invention, there is provided a communication system including a first party and a second party. The first party is configured to request a service on behalf of the second party. The first party is configured to send a request for a service on behalf of the second party. The request includes identity information of the second party. An authenticating entity authenticates the first party and modifies the request to include identity information of the first party. A service provider permits the first party to receive the service on behalf of the second party, depending on the identity information of at least the second party.

According to a fourth embodiment of the invention, there is provided a communication system comprising a first party and a second party. The first party is configured to request a service on behalf of the second party. The first party is configured to send a request for a service on behalf of the second party. The request includes identity information of the second party. A service provider is configured to permit the first party to receive the service on behalf of the second party, depending on the identity information.

### BRIEF DESCRIPTION OF THE DRAWINGS

For better understanding of the invention, reference will now be made by way of example only to the detailed examples of the embodiments shown in the accompanying drawings in which:

FIG. 1 shows a network environment in which embodiments of the invention can be implemented;

FIG. 2 shows the IMS network of FIG. 1 in more detail; and

FIG. 3 shows schematically an embodiment of the invention.

### DETAILED DESCRIPTION OF THE PREFERRED EMBODIMENTS

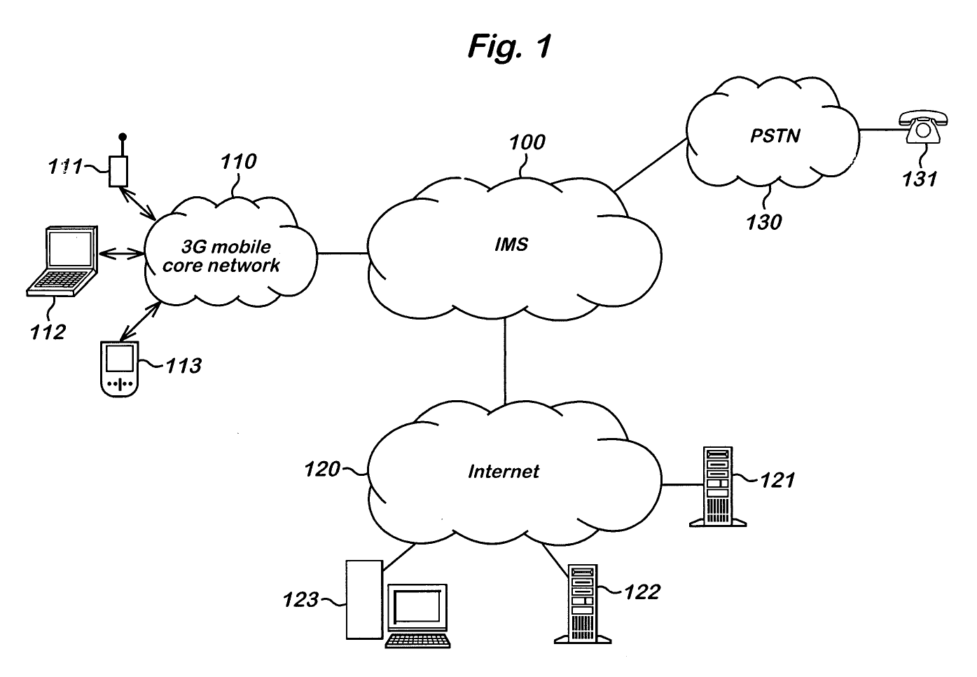

Reference will now first be made to the FIG. 1, which illustrates a typical 3^{rd} Generation (3G) Wireless telecommunications system operating under the Universal Mobile Telecommunications System (UMTS). At the hub of this system is the IP Multimedia Subsystem (IMS) 100 network, which routes calls and all kinds of sessions between two or more users (or between user and a network element e.g. application server) of the network and provides other network functions. Examples of users are mobile terminal 111, laptop 112, personal desktop assistant (PDA) 113, Public Switched Telephone Network (PSTN) telephone 131, computer terminal 123, and application server 121, and application server 122. The IMS uses an IP based network to handle these calls, which may include both voice calls and multimedia calls.

The IMS network effectively acts as a gateway in a 3G system between the users 111, 112, 113, and other networks such as a PSTN 130 and external IP based network 120. The users 111, 112 and 113 are connected to the IMS network 100 by a 3G core network 110. The 3G core network may include a UTRAN (UMTS terrestrial radio access network) which includes a network element node B (sometimes referred to as a base station), which provides equipment for transmission and reception of messages and may additionally include ciphering equipment. This node B communicates with a radio network controller 110 as is known in the art.

Signalling between the mobile terminal and other users of the IMS network, and within the IMS network, is done under the Session Initiation Protocol (SIP).

It should be appreciated that although the preferred embodiments of the invention have been described in the context of SIP, other embodiments of the invention can be implemented in non SIP environments.

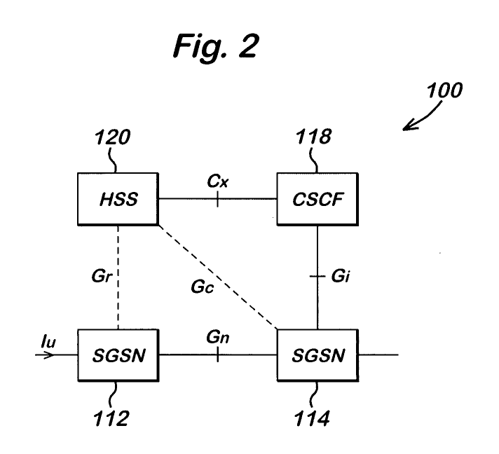

FIG. 2 illustrates the internet protocol (IP) multimedia network architecture in more detail. The RNC of the core network 110 sets up the radio channels for signalling to a core network node 112 which may include a serving General Packet Radio Service GPRS support node (SGSN). The signalling occurs over the Iᵤ interface. The SGSN provides the network access node and mobility management functions. The node 112 is a switching node which can perform connection management, mobility management and authentication activities. The core network node 112 is connected to the gateway GPRS support node (GGSN) 114 via the Gn interface. The GGSN provides access, via the Gᵢ interface, to the Internet 120 or PSTN 130. In practice a separate gateway may be provided for each different system to which the IMS network is connected.

The call state control function (CSCF) 118 supports and controls sessions during which the UE obtains IMS services from a service provider. In addition, CSCF may consist of Proxy, Interrogating and Serving CSCFs. The CSCF provides flexibility to modify, add or erase bearers used by the users services as will be discussed in more detail hereinafter. Amongst other functions the CSCF 118 controls call functions, thus executes call setup, modification and termination and performs address handling. The CSCF accesses the Home Subscriber Server (HSS) 120 via the Cₓ interface. The HSS is a master server containing data relating to a particular user. It contains data relating to a specific user which can identify how call services are to be carried out and authentication and authorization information. The HSS is located in the home network of the UE user which may be some distance from the location of the UE, which is serviced by a local (visited) network. The HSS is connected to the SGSN 114 and GGSN via the Gᵣ and G_{c} interfaces respectively.

The IM domain in 3GPP includes a number of different entities including a proxy call state control function (P-CSCF) which is the UE point of contact in the serving (visiting) network. It is this point where the network places constraints on the bearer supporting the session. P-CSCF corresponds to a SIP proxy in the general SIP framework. The IM domain also includes a serving call state control function (S-CSCF) which is located in the home network of the user and which is responsible for identifying the user's service privileges. S-CSCF corresponds to a SIP registrar in the general SIP framework. The S-CSCF selects and provides access to the home network provides authentication, authorization and accounting home server (AAA-H) which provides authentication, authorization and accounting checking. In addition the IM domain includes at least one interrogating call state control function (I-CSCF) which locates the S-CSCF upon a request for registration by the UE. I-CSCF corresponds to a SIP proxy in the general SIP framework.

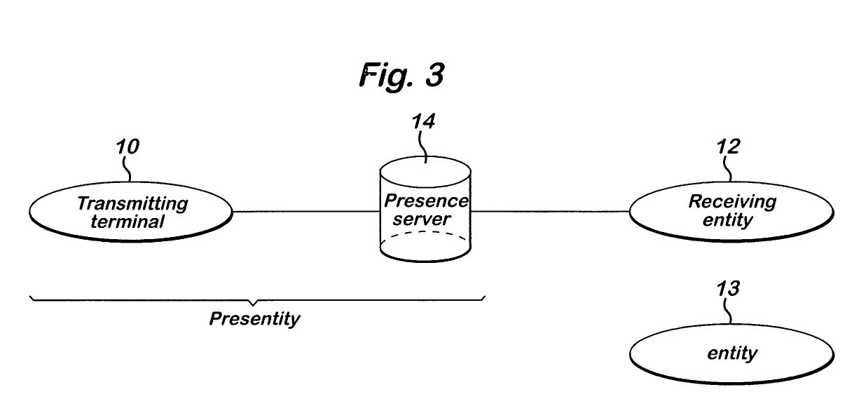

FIG. 3 shows a transmitting terminal 10 and a receiving terminal 12. The transmitting terminal 10 is arranged to provide presence information to the receiving entity 12 or watcher. A presence server 14 is provided. The transmitting terminal is sometimes referred to as a presentity. The presence server 14 provides the receiving entity 12 with the required presence information. The presence server 14 will receive the presence information from the transmitting terminal. It should be appreciated that the connection between the transmitting terminal 10 and the presence server 14 as well as the connection between the presence server 14 and the receiving terminal will be via network elements or entities not shown in this Figure. In embodiments of the invention, the receiving entity may act on behalf of another entity 13.

In the following description, various SIP messages are mentioned. Where appropriate, the messages are indicated in capital letters.

Embodiments of the invention propose to utilize the privacy mechanism for SIP as defined in the IETF standard RFC 3325 to allow the an entity to subscribe to a service or event such as presence on behalf of another user or entity. This is advantageously possible in SIP networks, where RFC 3325 is already utilized for other security purposes. One example of such SIP network is a 3GPP IMS network.

Embodiments of the invention may be applicable to any event package and are not restricted to presence event package and in any SIP network supporting RFC 3325 not just 3GPP IMS, where the notifier for the event package is part of the same trust domain where the subscriber is located.

In embodiments of the invention, the subscriber, when generating a SUBSCRIBE request, fills the FROM header of the SUBSCRIBE request with the SIP URI (universal resource identifier) of the entity, on whose behalf the subscription is made. In the arrangement shown in FIG. 3, this is entity 13. This is in accordance with draft-ietf-simple-event-list-00, where a Resource List Server subscribes for an event package on behalf of the user.

Assuming that the SIP network supports RFC 3325, the first SIP entity of the trust domain (the IMS network) capable of authenticating the source of the SUBSCRIBE request inserts the P-Asserted-Identity header field into the request. The P-Asserted-Identity header field contains a trustworthy identity on the source to the nodes part of the same trust domain (which might be the same or different from the user, on whose behalf the subscription is made). The P-Asserted-Identity header field (see IETF specification RFC 3325) is a header field that contains a URI (commonly a SIP URI) and an optional display-name, for example:

P-Asserted-Identity: “Cullen Jennings” <sip:fluffy@cisco.com>

A proxy server which handles a message can, after authenticating the originating user in some way (for example: Digest authentication), insert such a P-Asserted-Identity header field into the message and forward it to other trusted proxies. There are two cases.

In the first case, the FROM header field is inserted by the source of the SUBSCRIBE request itself. This may be used for network-based watchers, when the watcher is located in the network and the other network elements which are part of the same trust domain as the watcher trust the information coming from the network-based watcher. In this case, the P-Asserted-Identity header field also contains the identity of the user on whose behalf the subscription is made, similarly to the FROM header field.

In the second case, when the source of the SUBSCRIBE request is located outside of the trust domain of the presentity's Presence Server, then there will be a proxy server at the edge of the trust domain capable of authenticating the source of the SUBSCRIBE request. This proxy server can insert the corresponding P-Asserted-Identity header field to the request. This is the typical case when a user sends a SUBSCRIBE request on behalf of another user. In this case, the authenticating proxy will insert the identity of the actual subscriber, on who is making the request in the P-Asserted-Identity header field, which is now different from the identity of the user on whose behalf the subscription is made.

When the Presence Server of the presentity receives the SUBSCRIBE request, first the presence server looks for authorization information. The authorization policy provided by the presentity may include authorization information for the user on whose behalf the subscription is made. The primary information for the authorization is based on the user on whose behalf the subscription is made (i.e. the FROM header field of the SUBSCRIBE request) and the identity of the actual subscriber (may be included in the P-Asserted-Identity header field) is only taken as secondary information for the authorization. This means that the presentity first authorizes the user on whose behalf the subscription is made (this determines whether the subscription is accepted or not) and as the next level of authorization, the presentity authorizes the actual subscriber who generated the SUBSCRIBE request (this level of authorization determines the actual content of the presence information provided to the subscriber).

Here are two examples:

1. Alice subscribes to Bob's presence information on behalf of Steve using 3GPP Rel-6 IMS Presence Service: Alice is the watcher and Bob is the presentity.

Alice sends a SUBSCRIBE request (Alice's UE (watcher) to the P-CSCF.

This message is

SUBSCRIBE sip:bob@home2.net SIP/2.0

Via: SIP/2.0/UDP

[5555::aaa:bbb:ccc:ddd]:1357;comp=sigcomp;branch=z9hG4bKnashds7

Max-Forwards: 70

P-Access-Network-Info: 3GPP-UTRAN-TDD; utran-cell-id-3gpp=234151D0FCE11

Route: <sip:pcscf1.visited1.net:7531;1r;comp=sigcomp>, <sip:orig@scscf1.home1.net;1r>

P-Preferred-Identity: <sip:alice@home1.net>

Privacy: none

From: <sip:steve@home1.net>;tag=31415 (This is the From header and has the identity of the enity on whose behalf Alice requests—that is Steve)

To: <sip:bob@home2.net>

Call-ID: b89rjhnedlrfjflslj40a222

CSeq: 61 SUBSCRIBE

Require: sec-agree

Proxy-Require: sec-agree

Security-Verify: ipsec-3gpp; q=0.1; alg=hmac-sha-1-96; spi=87654321; portl=7531

Event: presence

Expires: 7200

Accept: application/cpim−pidf+xml

Contact: <sip:[5555::aaa:bbb:ccc:ddd]:1357;comp=sigcomp>Content-Length: 0

P-CSCF is the first element of the IMS trust domain. Based on underlying security it is able to authenticate the source of the request, that is Alice and insert the P-Associated-URI header field of Alice. P-CSCF also takes into account the P-Preferred-Identity header field provided by Alice when generating the P-Asserted-Identity header field. In other words the P-CSCF uses Alice's preferred identity in the P-Asserted-Identity header field. After inserting the P-preferred-Identity header, the SUBSCRIBE request is sent from the P-CSCF to the S-CSCF.

SUBSCRIBE sip:bob@home2.net SIP/2.0

Via: SIP/2.0/UDP pcscf1.home1.net;branch=z9hG4bK240f34.1, SIP/2.0/UDP

[5555::aaa:bbb:ccc:ddd]:1357;comp=sigcomp;branch=z9hG4bKnashds7

P-Access-Network-Info: 3GPP-UTRAN-TDD; utran-cell-id-3gpp=234151D0FCE11

Route: <sip:orig@scscf1.home1.net;1r>

Max-Forwards: 69

P-Asserted-Identity: <sip:alice@home1.net>(this is the identity of the actual source of the request which has been inserted by the P-CSCF)

Privacy: none

Record-Route: <sip:pcscf1.home1.net;1r>

From: <sip:steve@home1.net>;tag=31415

To: <sip:bob@home2.net>

Call-ID: b89rjhnedlrfjflslj40a222

CSeq: 61 SUBSCRIBE

Event: presence

Expires: 7200

Accept: application/cpim−pidf+xml

Contact: <sip:[5555::aaa:bbb:ccc:ddd]:1357;comp=sigcomp>

Content-Length: 0

When the Presence Server of Bob receives the SUBSCRIBE request, first it must look for authorization information. Assuming that the authorization policy provided by Bob includes authorization information for Steve when somebody subscribes for Bob's presence information on his behalf (in this case, Alice), the Presence Server installs Alice's subscription as dictated by the authorization policy. In other words, the presence server first checks to see if Steve is authorized to obtain presence information about Bob. Only if Steve is authorized to obtain the presence information will the presence server check to see if Alice is authorised to obtain the information on behalf of Steve. In other embodiments of the invention, the checks can be done the other way round or at substantially the same time.

2. Steve's Resource List Server subscribes to Bob's presence information on behalf of Steve using 3GPP Rel-6 IMS Presence Service:

A SUBSCRIBE request is sent from the RLS (resource list server) to the S-CSCF

SUBSCRIBE sip:bob@home2.net SIP/2.0

Via: SIP/2.0/UDP rls.home1.net;branch=z9hG4bKehuefdam

Max-Forwards: 70

Route: <sip:scscf1.home1.net;1r>

P-Asserted-Identity: <sip:steve@home1.net>

From: <sip:steve@home1.net>;tag=31415

To: <sip:bob@home2.net>

Call-ID: q987a9a87g087abgf7qyg7ag

CSeq: 123 SUBSCRIBE

Event: presence

Expires: 7200

Accept: application/cpim−pidf+xml

Contact: <sip:pls.home1.net>

Content-Length: 0

In this example, the RLS is part of the same trust domain as Bob's Presence Server (Bob's Presence Server trusts the information coming from Steve's RLS), so that the content of the P-Asserted-Identity header field is carried to the Presence server. The P-Asserted identity field is in the subscribe message generated by the RLS. The RLS is part of the trusted domain, so that the next hops of the message will not remove this header.

When the Presence Server of Bob receives the SUBSCRIBE request, first it must look for authorization information. Assuming that the authorization policy provided by Bob includes authorization information for Steve, the Presence Server installs Steve's subscription as dictated by the authorization policy.

Note that in this case, the Presence Server does not even realize that the SUBSCRIBE request is sent by the RLS on behalf of Steve. This is adequate, if there is a trust relationship between Steve and his RLS, so that the RLS can act on behalf of Steve (it is capable of performing authentication on behalf of Steve). From the presentity point of view, this is the correct behaviour, as Bob is probably not able to decide whether the RLS (as a network-based watcher) is an authorized subscriber on behalf of Steve, therefore it is better to hide the identity of the RLS.

In one preferred embodiment of the invention, a check is made to see if the P-Asserted Identity header is the same as the FROM header. If they are, it can be assumed that only a single level of authorization as in example 2 would be required. If they are not, as in example 1, then the two level authorization process is required as described in relation to that example.

In preferred embodiments of the invention, identity information is included in the FROM header and P-Asserted identity. In alternative embodiments of the invention, other fields may instead or additionally or in combination, contain this information. The identity information is preferably a SIP URI but can alternatively take any other suitable form.

Embodiments of the invention have been disclosed in the context of an IMS and SIP system. Other embodiments of the invention may not be in the context of an IMS and/or SIP environment.

Embodiments of the invention have been described in the context of presence services. It should be appreciated that embodiments of the invention can be used with any other service. The term “service” will be understood to broadly cover any service or goods which a user may desire, require or be provided with. The term also will be understood to cover the provision of complimentary services. In particular, but not exclusively, the term “service” will be understood to include internet multimedia services (IMS), conferencing, telephony, gaming, rich call, presence, e-commerce and instant messaging.

Another example is conferencing if somebody joins a conference on behalf of somebody else. Authorization shall be based on the “on behalf” user, on a primary level, and on the actual participant, on a secondary level. This example may be similar to that given about but the message used would be the INVITE message instead of the SUBSCRIBE message. Here are the corresponding INVITEs for the example 1 discussed above. In this example Alice will subscribe to a conference call on behalf of Steve:

This message is sent by Alice to the P-CSCF.

INVITE sip:conference 123@mrfc.home1.net SIP/2.0

Via: SIP/2.0/UDP

[5555::aaa:bbb:ccc:ddd]:1357;comp=sigcomp;branch=z9hG4bKnashds7

Max-Forwards: 70

Route: <sip:pcscf1.visited1.net:7531;1r;comp=sigcomp>,

<sip:scscf1.home1.net;1r>

P-Preferred-Identity: <sip:alice@home1.net>This identifies the requester of the service—that is Alice

P-Access-Network-Info: 3GPP-UTRAN-TDD; utran-cell-id-3gpp=234151D0FCE11

Privacy: none

From: <sip:steve@home1.net>; tag171828 Here is the From headere which has the identity of the entity (Steve) on whose behalf Alice makes the request.

To: <sip:conference123@mrfc.home1.net>This identifies that the service is a conference call.

Call-ID: cb03a0s09a2sdfg1kj490333

Cseq: 127 INVITE

Require: precondition, sec-agree

Proxy-Require: sec-agree

Supported: 100rel

Security-Verify: ipsec-3gpp; q=0.1; alg=hmac-sha-1-96; spi=87654321;

portl=7531

Contact: <sip:[5555::aaa:bbb:ccc:ddd]:1357;comp=sigcomp>

Content-Type: application/sdp

Content-Length: ( . . . )

v=0

o=−2987933615 2987933615 IN IP6 5555::aaa:bbb:ccc:ddd

s=−

c=IN IP6 5555::aaa:bbb:ccc:ddd

t=907165275 0

m=video 3400 RTP/AVP 98 99

b=AS:54.6

a=curr:qos local none

a=curr:qos remote none

a=des:qos mandatory local sendrecv

a=des:qos none remote sendrecv

a=rtpmap:98 H261

a=rtpmap:99:MPV

m=video 3402 RTP/AVP 98 99

b=AS :54.6

a=curr:qos local none

a=curr:qos remote none

a=des:qos mandatory local sendrecv

a=des:qos none remote sendrecv

a=rtpmap:98 H261

a=rtpmap:99:MPV

m=audio 3456 RTP/AVP 97 96 0 15

b=AS :25.4

a=curr:qos local none

a=curr:qos remote none

a=des:qos mandatory local sendrecv

a=des:qos none remote sendrecv

a=rtpmap:97 AMR

a=fmtp:97 mode-set=0,2,5,7; maxframes=2

a=rtpmap:96 G726-32/8000

m=audio 3458 RTP/AVP 97 96 0 15

b=AS:25.4

a=curr:qos local none

a=curr:qos remote none

a=des:qos mandatory local sendrecv

a=des:qos none remote sendrecv

a=rtpmap:97 AMR

a=fmtp:97 mode-set=0,2,5,7; maxframes=2

a=rtpmap:96 G726-32/8000

the INVITE message sent from the P-CSCF to the S-CSCF is as follows:

INVITE sip:conference 123@mrfc.home1.net SIP/2.0

Via: SIP/2.0/UDP pcscf1.visited1.net;branch=z9hG4bK240f34.1,

SIP/2.0/UDP

[5555::aaa:bbb:ccc:ddd]:1357;comp=sigcomp;branch=z9hG4bKnashds7

Max-Forwards: 69

Route: <sip:scscf1.home1.net;1r>

Record-Route: <sip:pcscf1.visited1.net;1r>

P-Asserted-Identity: <sip:alice@home1.net>The P-CSCF inserts Alices

identity into this field to thereby indicated that Alice is authenticated and a

trusted source

P-Access-Network-Info: 3GPP-UTRAN-TDD; utran-cell-id-3gpp=234151DOFCE11

P-Charging-Vector: icid-value=1234bcd9876e; icid-generated-at=[5555::f5f:e4e:d3d:c2c]

Privacy: none

From: <sip:steve@home1.net>; tag=171828

To: <sip:conference 123 @mrfc.home1.net>

Call-ID: cb03a0s09a2sdfglkj490333

Cseq: 127 INVITE

Require: precondition

Supported: 100rel

Contact: <sip:[5555::aaa:bbb:ccc:ddd]:1357;comp=sigcomp>

Content-Type: application/sdp

Content-Length: ( . . . )

v=0

o=−2987933615 2987933615 IN IP6 5555::aaa:bbb:ccc:ddd

s=−

c=IN IP6 5555::aaa:bbb:ccc:ddd

t=907165275 0

m=video 3400 RTP/AVP 99

b=AS:54.6

a=curr:qos local none

a=curr:qos remote none

a=des:qos mandatory local sendrecv

a=des:qos none remote sendrecv

a=rtpmap:99:MPV

m=video 3402 RTP/AVP 99

b=AS:54.6

a=curr:qos local none

a=curr:qos remote none

a=des:qos mandatory local sendrecv

a=des:qos none remote sendrecv

a=rtpmap:99:MPV

m=audio 3456 RTP/AVP 97 96 0 15

b=AS:25.4

a=curr:qos local none

a=curr:qos remote none

a=des:qos mandatory local sendrecv

a=des:qos none remote sendrecv

a=rtpmap:97 AMR

a=fmtp:97 mode-set=0,2,5,7; maxframes=2

a=rtpmap:96 G726-32/8000

m=audio 3458 RTP/AVP 97 96 0 15

b=AS:25.4

a=curr:qos local none

a=curr:qos remote none

a=des:qos mandatory local sendrecv

a=des:qos none remote sendrecv

a=rtpmap:97 AMR

a=fmtp:97 mode-set=0,2,5,7; maxframes=2

a=rtpmap:96 G726-32/8000

It should be appreciated that while the above refers to mobile user equipment such as mobile stations, embodiments of the invention are applicable to any other suitable type of user equipment such as personal computers (PDA), personal data assistants (PDA) any SIP terminal or any other suitable terminal.

It is also noted herein that while the above describes exemplifying embodiments of the invention, there are several variations and modifications which may be made to the disclosed solution without departing from the scope of the invention as defined in the appended claims.

1. A method of requesting a service by one party on behalf of another party, the method comprising the steps of:
requesting by one party a service on behalf of another party, a request including identity information of the another party;
authenticating the one party and modifying said request to include identity information of the one party; and
permitting the one party to receive the service on behalf of said another party, depending on the identity information of at least the another party.

2. A method as claimed in claim 1, wherein said authenticating step is carried out by a first entity in a same domain as a second entity carrying out said permitting step.

3. A method as claimed in claim 1, wherein said authenticating step is carried out by a proxy server located at an edge of a domain containing an entity carrying out the permitting step.

4. A method as claimed in claim 1, wherein said authenticating step is performed by a proxy call state control function.

5. A method as claimed in claim 1, wherein said requesting step comprises requesting said service comprising an Internet Protocol Multimedia Subsystem service.

6. A method as claimed in claim 1, wherein said requesting step comprises requesting said service comprising at least one of a presence service and a conferencing service.

7. A method as claimed in claim 6, wherein said permitting step is carried out by at least one of a presence server and a conferencing server.

8. A method as claimed in claim 1, wherein said requesting step comprises requesting said request comprising a Session Initiation Protocol request.

9. A method as claimed in claim 8, wherein said requesting step comprises requesting the SIP request comprising a SUBSCRIBE or INVITE message.

10. A method as claimed in claim 9, wherein said authenticating step further comprises including the identity information of the another party in a From header field.

11. A method as claimed in claims 8, wherein said authenticating step further comprises including the identity information of the one party in a P-Asserted Identity field.

12. A method of requesting a service by one party on behalf of another party, said method comprising the steps of:
requesting by one party a service on behalf of another party, a request including identity information of said another party; and
permitting the one party to receive the service on behalf of the another party depending on said identity information.

13. A method as claimed in claim 12, wherein said permitting step comprises permitting said one party to be part of a same domain as an entity which carries out the permitting step.

14. A method as claimed in claim 12, wherein said requesting step comprises requesting by said one party comprising a server requesting a service on behalf of the another party.

15. A method as claimed in claim 14, wherein said requesting step comprises requesting by said one party comprising a server comprising a resource list server.

16. A method as claimed in claim 12, wherein said permitting step is performed by an application server.

17. A method as claimed in claim 16, wherein said permitting step is performed by said application server comprising at least one of a presence server and a conferencing server.

18. A method as claimed in claim 12, wherein said requesting step comprises requesting said request including said identity information comprising a SIP URI.

19. A method as claimed in claim 12, wherein said requesting step comprises requesting said request including said identity information comprising a SIP URT.

20. A communication system comprising:
a first party and a second party, the first party being configured to request a service on behalf of the second party, the first party being configured to send a request for a service on behalf of the second party, the request including identity information of the second party;
an authenticating entity for authentication the first party and configured to modify said request to include identity information of the first party; and
a service provider configured to permit the first party to receive the service on behalf of said second party, depending on the identity information of at least the second party.

21. A system as claimed in claim 20, wherein said authentication entity comprises a proxy server located at an edge of a domain containing said service provider.

22. A system as claimed in claim 20, wherein said authentication entity comprises a proxy call state control function.

23. A communication system comprising:
a first party and a second party, the first party being configured to request a service on behalf of the second party, the first party being configured to send a request for a service on behalf of the second party, the request including identity information of the second party; and
a service provider configured to permit the first party to receive the service on behalf of said second party, depending on the identity information.

24. A communication system comprising:
requesting means for requesting by one party a service on behalf of another party, a request including identity information of the another party;
authenticating means for authenticating the one party and modifying said request to include identity information of the one party; and
permitting means for permitting the one party to receive the service on behalf of said another party, depending on the identity information of at least the another party.

25. A communication system comprising:
requesting means for requesting by one party a service on behalf of another party, a request including identity information of said another party; and
permitting means for permitting the one party to receive the service on behalf of the another party depending on said identity information.
